(19) United States
(12) Patent Application Publication
(10) Pub. No.: US 2005/0249158 A1
(43) Pub. Date: Nov. 10, 2005

(54) Method for making uplink transmission plan for multiple user terminals having different radio environments for sateelite system offering bursts of various durations and bandwidhts

(76) Inventors: Abheek Saha, Haryana (IN); Harpreet Kaur, Haryana (IN)

Correspondence Address: NIXON & VANDERHYE, PC, 901 NORTH GLEBE ROAD, 11TH FLOOR, ARLINGTON, VA, 22203, US

(21) Appl. No.: 10/966,025

(22) Filed: Oct. 18, 2004

Related U.S. Application Data
(60) Provisional application No. 60/511,692, filed on Oct. 17, 2003.

(51) Int. Cl. H04Q 7/00; H04L 12/28

(52) U.S. Cl. 370/329; 370/235

(57) ABSTRACT

The present invention relates to a method for making an uplink transmission plan for a satellite system which supports multiple user terminals per channel and which allows the usage of multiple burst plans at the physical layer, having different duration and bandwidth combinations, as well as individual connections having different known channel conditions when using the system.

The present invention relates to a method for making an uplink transmission plan for a satellite system. More particularly, the present invention relates to a method for making an uplink transmission plan for a satellite system which supports multiple user terminals per channel. The present invention also provides a method for making an uplink transmission plan for a satellite system which allows the usage of multiple burst plans at the physical layer, having different duration and bandwidth combinations, as well as individual connections having different known channel conditions when using the system.

The underlying physical channel in a satellite system has a TDMA structure. The channel has frames of a given fixed duration and within the frame, multiple transmission units or bursts are defined. The bursts are not necessarily of the same length (in duration), but the total duration has to match the frame duration.

Each channel has a given width and the user terminals may use a variety of bursts of duration and bandwidth such that an integral number of burst durations can add up to the channel frame duration or the channel bandwidth. For example, the channel may be 100 khz wide and have a frame timing of 40 ms, and support bursts which are either 20 ms long or 10 ms long (in duration) and 50 Khz wide or 100 Khz wide (in bandwidth)

The user terminals have differing radio conditions, which means that for a given burst, two different user terminals will be able to transmit different amounts of user data

The burst definition is such that for a given radio-condition, if there are two bursts in such a manner that one is larger than the other (in duration or bandwidth or both), the amount of user data (henceforth called payload) that can be packed on the one burst is not necessarily proportionately larger than the amount of user data that can be packed on the other. The amount of user data is either more than the proportional number or less than the proportional number.

There is a requirement to support multiple scheduling disciplines.

Accordingly, the method of the invention comprises;
(a) executing a scheduling discipline to generate a list of connections to service and the minimum and maximum number of bytes that have to be serviced per connection,
(b) creating a transmission plan at periodic intervals, the transmission plan comprising duration and bandwidth,
(c) converting the transmission duration into a grid unit with duration in the X-axis and bandwidth in the Y-axis,
(d) computing the hypothetical payload for the grid unit by proportionately scaling the payload of the smallest burst,
(e) servicing each connection in turn beginning with a first connection at the head of the sorted list of connections.

In one embodiment of the invention, in step (b), the periodic intervals comprise one or an integral number of frames.

In another embodiment of the invention, in step (c) the grid unit is set to the greatest common denominator for all defined bursts.

In another embodiment of the invention, in step (d) the hypothetical payload size is made available to all possible combinations of radio environments and link margin, as appropriate to the existing connections.

In another embodiment of the invention, in step (e) wherein the servicing of each connection comprises:
(a) sorting the entries in the generated list of connections such that the entry with the largest minimum service required is at the head of the list;
(b) computing the minimum number of grid units required to service both the minimum amount of bytes to service as well as the maximum number of bytes to service and rounding the number of grid units generated to the next highest integer number;
(c) preparing a list of bursts required to service the connection based on the number of grid units required, and sorting out the bursts in terms of efficiency;
(d) identifying a place within the grid for each burst, beginning with the most efficient burst;
(e) updating the master grid once a burst location is identified
(f) repeating the process till the grid is exhausted or till the number of connection in the list to be serviced is exhausted.

In another embodiment of the invention, during the servicing of the connection, if the minimum service required is equal, the maximum service required is used to discriminate.

In another embodiment of the invention, during the servicing of the connection, for each connection to be serviced, the bytes to be serviced are set to the minimum bytes to service.

In another embodiment of the invention, during the servicing of the connection, if the minimum bytes to service is zero, the maximum number of bytes is used to service the connection.

In another embodiment of the invention, the further list of bursts begins with the burst with the least payload greater than the number of bytes to be serviced and includes all bursts with payload smaller than the first burst.

In another embodiment of the invention, the payload is computed differently for each connection, depending on the radio-environment of the connection.

In another embodiment of the invention, the efficiency of a burst is computed as the payload of a burst divided by the number of grid units it occupies.

In another embodiment of the invention, the grid represents the channel for the scheduling period for the burst.

In another embodiment of the invention, if a particular connection has already been allotted a first burst, the new burst placement is such that it allows sufficient margin for the first burst.

In another embodiment of the invention, if the first burst is not possible, further attempts at placement in the grid are attempted.

In another embodiment of the invention, if no burst placement is possible, the specific connection is deleted from the list and the list repeated.

In another embodiment of the invention, the number of bytes that can be serviced from a connection is computed based on the burst type, the radio-environment that the connection experiences and the link margin required by the connection and debited from both the minimum number of bytes to service and the maximum number of bytes to service, and wherein if both are zero, the connection is removed from the list.

As explained above, the method of this invention comprises.
The transmission plan is created at periodic intervals, which may be one or an integral number of frames.
Prior to creating the plan, the scheduling discipline is executed. It generates a list of connections to service and the minimum and maximum number of bytes that have to be serviced per connection.
The transmission duration is broken into a grid, with the duration in the X-axis and the bandwidth in the Y-axis. The grid unit is set to the greatest common denominator for all defined bursts. Note that there may not be any defined burst which matches the grid.
For the grid unit, compute the hypothetical payload size by proportionately scaling the payload of the smallest burst. The hypothetical payload size should be available for all possible combinations of radio environments and link margin, as appropriate to the existing connections.
We start with the first connection at the head of the sorted queue and service each connection in turn. The manner of service is as follows:
   a) The entries in the queue are sorted so that the entry with the largest minimum service required is at the head. If the minimum service required is equal, use the maximum service required to discriminate. For each connection to be serviced, we set the bytes to be serviced to the minimum bytes to service. If minimum bytes to service is zero, we use the maximum number of bytes to service.
   b) For each entry in the scheduled queue, the minimum number of grid units required to service both the minimum amount of bytes to service as well as the maximum number of bytes to service is computed and rounded off to the next highest integer number.
   c) Based on the number of grid units required, we short list the bursts that may be used to service this connection. The shortlist starts with the burst with the least payload greater than the number of bytes to be serviced and includes all bursts with payload smaller than the first burst. Note that the payload is computed differently for each connection, depending on the radio-environment of the connection. The list is sorted in order of efficiency. Efficiency of a burst is computed as the payload of a burst divided by the number of grid units it occupies.
   d) Starting with the most efficient burst, we try to find a place within the grid (representing the channel for the scheduling period) for the burst. If the particular connection has been already allotted a burst, the placement ensures that the new burst placement is such that it allows sufficient margin for the previous burst. If the first burst is not possible, we continue on. If at least one possible burst is available we continue to the next step. Else, delete this connection from the queue and repeat.
   e) Once the burst is found, it is updated in the master grid. The number of bytes that can be serviced from this connection is computed (based on the burst type, the radio-environment that the connection experiences and the link margin required by the connection) and debited from both the minimum number of bytes to service and the maximum number of bytes to service. If both turn out zero, we remove the connection from the entry.
   f) The process is repeated till the grid is exhausted, or there are no more connections to be serviced.

The above description should not be construed as limiting in any manner. Work is still underway in completing the invention. It will be evident that modifications and variations are possible without departing from the scope and spirit of the invention.

1. A method for making an uplink transmission plan for a satellite system, the method comprising:
(f) executing a scheduling discipline to generate a list of connections to service and the minimum and maximum number of bytes that have to be serviced per connection;
(g) creating a transmission plan at periodic intervals, the transmission plan comprising duration and bandwidth;
(h) converting the transmission duration into a grid unit with duration in the X-axis and bandwidth in the Y-axis;
(i) computing the hypothetical payload for the grid unit by proportionately scaling the payload of the smallest burst;
(j) servicing each connection in turn beginning with a first connection at the head of the sorted list of connections;

2. A method as claimed in claim 1 wherein in step (b), the periodic intervals comprise one or an integral number of frames.

3. A method as claimed in claim 1 wherein in step (c) the grid unit is set to the greatest common denominator for all defined bursts.

4. A method as claimed in claim 1 wherein in step (d) the hypothetical payload size is made available to all possible combinations of radio environments and link margin, as appropriate to the existing connections.

5. A method as claimed in claim 1 wherein in step (e) wherein the servicing of each connection comprises:
(g) sorting the entries in the generated list of connections such that the entry with the largest minimum service required is at the head of the list;
(h) computing the minimum number of grid units required to service both the minimum amount of bytes to service as well as the maximum number of bytes to service and rounding the number of grid units generated to the next highest integer number;
(i) preparing a list of bursts required to service the connection based on the number of grid units required, and sorting out the bursts in terms of efficiency;
(j) identifying a place within the grid for each burst, beginning with the most efficient burst;
(k) updating the master grid once a burst location is identified
(l) repeating the process till the grid is exhausted or till the number of connection in the list to be serviced is exhausted.

6. A method as claimed in claim 5 therein in step (a) if the minimum service required is equal, the maximum service required is used to discriminate.

7. A method as claimed in claim 5 wherein in step (a) for each connection to be serviced, the bytes to be serviced are set to the minimum bytes to service.

8. A method as claimed in claim 7 wherein if the minimum bytes to service is zero, the maximum number of bytes is used to service the connection.

9. A method as claimed in claim 5 wherein in step (c) the further list of bursts begins with the burst with the least payload greater than the number of bytes to be serviced and includes all bursts with payload smaller than the first burst.

10. A method as claimed in claim 5 wherein in step (c) the payload is computed differently for each connection, depending on the radio-environment of the connection.

11. A method as claimed in claim 5 wherein in step (c) wherein the efficiency of a burst is computed as the payload of a burst divided by the number of grid units it occupies.

12. A method as claimed in claim 5 wherein in step (d) the grid represents the channel for the scheduling period for the burst.

13. A method as claimed in claim 5 wherein in step (d) if a particular connection has already been allotted a first burst, the new burst placement is such that it allows sufficient margin for the first burst.

14. A method as claimed in claim 13 wherein if the first burst is not possible, further attempts at placement in the grid are attempted.

15. A method as claimed in claim 5 wherein in step (d) if no burst placement is possible, the specific connection is deleted from the list and the list repeated.

16. A method as claimed in claim 5 wherein the number of bytes that can be serviced from a connection is computed based on the burst type, the radio-environment that the connection experiences and the link margin required by the connection and debited from both the minimum number of bytes to service and the maximum number of bytes to service, and wherein if both are zero, the connection is removed from the list.
